(19) United States
(12) Patent Application Publication
(10) Pub. No.: US 2019/0227618 A1
(43) Pub. Date: Jul. 25, 2019

(54) Power Management for a Data Storage Apparatus

(71) Applicant: Goke US Research Laboratory, Santa Clara, CA (US)

(72) Inventors: Yung-Tzu Huang, Santa Clara, CA (US); Bo-Shian Hsu, Santa Clara, CA (US); Po-Chien Chang, Santa Clara, CA (US)

(21) Appl. No.: 15/877,521

(22) Filed: Jan. 23, 2018

(51) Int. Cl. G06F 1/32; G06F 9/4401

(52) U.S. Cl. CPC G06F 1/3275; G06F 9/4418; G06F 1/3287

(57) ABSTRACT

A data storage apparatus includes a NAND flash memory, an external memory and two cores. The external memory includes a first portion and a second portion smaller than the first portion. Each of the cores includes a CPU, an ITCM and a DTCM. The data storage apparatus is switchable between an operative state and hibernation. In the hibernation, the NAND flash memory, the first portion of the external memory, the CPU of the first core, and the CPU, ITCM and DTCM of the second core are shut down while the second portion of the external memory and the ITCM and DTCM of the first core are kept awake.

### BACKGROUND OF INVENTION

### 1. Field of Invention

The present invention relates to power management for a data storage device and, more particularly, to power management that reaches good balance between low power consumption and high performance.

### 2. Related Prior Art

Referring to FIG. 1, a host 10 is connected to a data storage apparatus. In specific, data storage apparatus is a solid-state drive (“SSD”) 12 including a NAND flash memory 14, an external memory 16 and two cores 18 and 20. Core 18 includes a central processor unit (“CPU”) 24, an instruction-tightly-coupled memory (“ITCM”) 26 and a data-tightly-coupled memory (“DTCM”) 28. ITCM 26 stores software programs to be run in CPU 24. DTCM 28 stores data needed in the operation of core 18. Core 20 includes a CPU 30, an ITCM 32 and a DTCM 34. ITCM 32 stores software programs to be run in CPU 30. DTCM 34 stores data needed in the operation of core 20.

SSD 12 receives data from host 10 and stores the data. Yet, SSD 12 is not always in need. There are idle situations in which communication of data of host 10 with SSD 12 is not needed. A typical power management method includes a hibernation routine and a wake-up routine. The hibernation routine is executed to put SSD 12 into hibernation to reduce power consumption in such idle situations. The wake-up routine is executed to wake up SSD 12 from the hibernation when host 10 has to communicate with SSD 12.

Referring to FIG. 6, entire cores 18 and 20, entire NAND flash memory 14 and entire external memory 16 are shut down in the hibernation. That is, CPU 24, ITCM 26 and DTCM 28 of core 18 are shut down, and CPU 30, ITCM 32 and DTCM 34 of core 20 are shut down.

Referring to FIG. 7, the wake-up routine is executed to wake up SSD 12, i.e., entire NAND flash memory 14, entire external memory 16 and entire cores 18 and 20. To this end, a boot ROM code is executed before a boot loader code. The boot loader code is executed before initializing codes of cores 18 and 20. The initializing code of core 20 is executed in parallel with the initializing code of core 18. The initializing codes of cores 18 and 20 are executed before the firmware of cores 18 and 20. The firmware of core 20 is executed in parallel with the firmware of core 18. Hence, it takes a long period of time to wake up SSD 12, i.e., there is a long latency in the operation of SSD 12. However, such a long latency in the operation of SSD 12 is intolerable in some cases.

The present invention is therefore intended to obviate or at least alleviate the problems encountered in prior art.

### SUMMARY OF INVENTION

It is the primary objective of the present invention to provide a data storage apparatus with a power management method that reaches balance between low power consumption and high performance.

To achieve the foregoing objective, the data storage apparatus includes a NAND flash memory, an external memory and two cores. The external memory is divided into a first portion and a second portion smaller than the first portion. Each of the cores includes a CPU, an ITCM and a DTCM. The data storage apparatus is switchable between an operative state and hibernation. In the hibernation, the NAND flash memory, the first portion of the external memory, the CPU of the first core, and the CPU, ITCM and DTCM of the second core are shut down while the second portion of the external memory and the ITCM and DTCM of the first core are kept awake.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a block diagram of a host and a data storage apparatus;

FIG. 2 is a block diagram of the data storage apparatus shown in FIG. 1 put in hibernation by a power management method according to the preferred embodiment of the present invention;

FIG. 3 shows phases of a wake-up routine of the data storage apparatus shown in FIG. 2;

FIG. 4 is a flow chart of a hibernation routine of the power management method according to the preferred embodiment of the present invention for putting the data storage apparatus into the hibernation;

FIG. 5 is a flow chart of a wake-up routine of the power management method according to the preferred embodiment of the present invention for waking up the data storage apparatus from the hibernation according to the preferred embodiment of the present invention;

FIG. 6 is a block diagram of the data storage apparatus shown in FIG. 1 in hibernation according to a conventional power management method; and

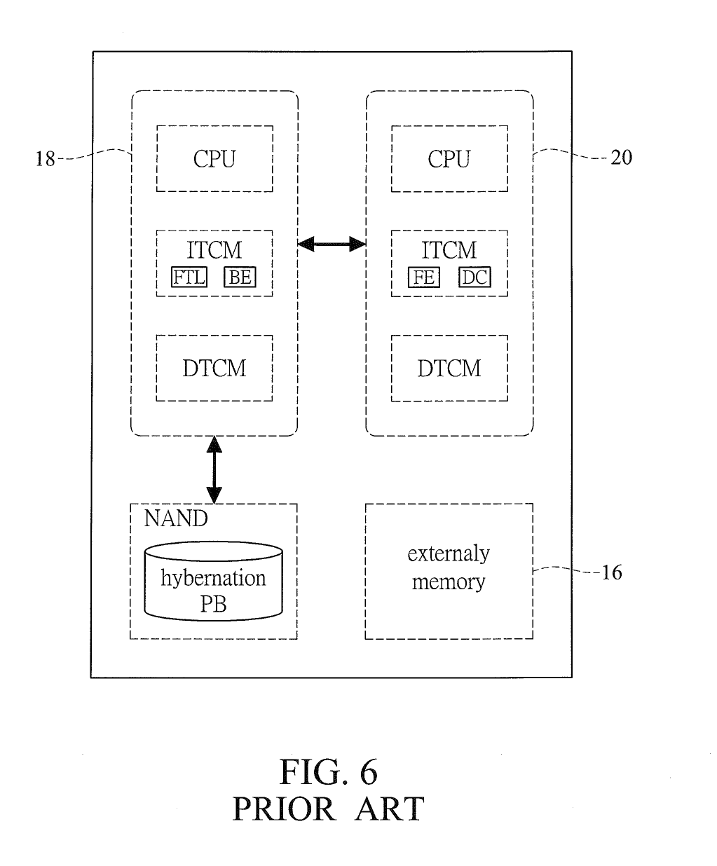

FIG. 7 shows phases of a wake-up routine of the data storage apparatus shown in FIG. 6.

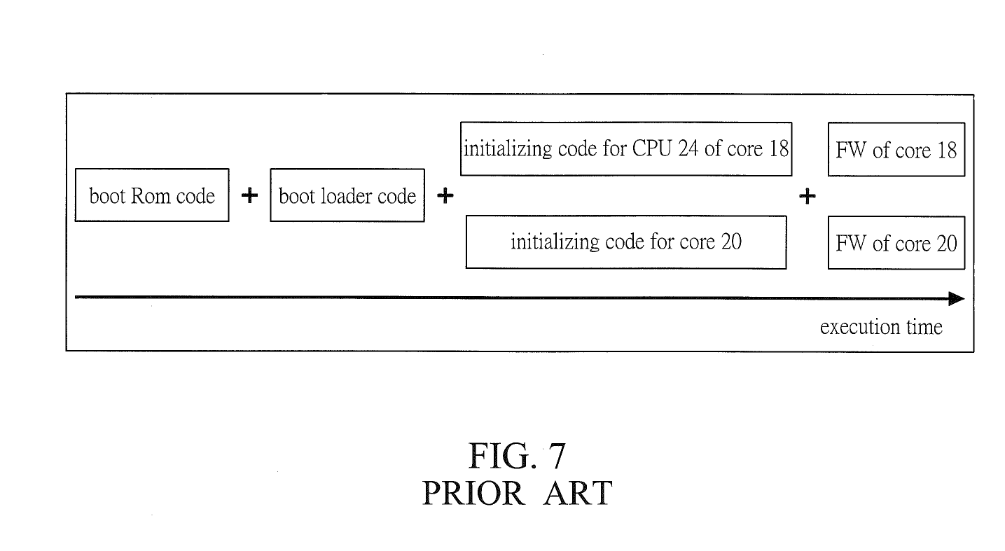

### DETAILED DESCRIPTION OF PREFERRED EMBODIMENT

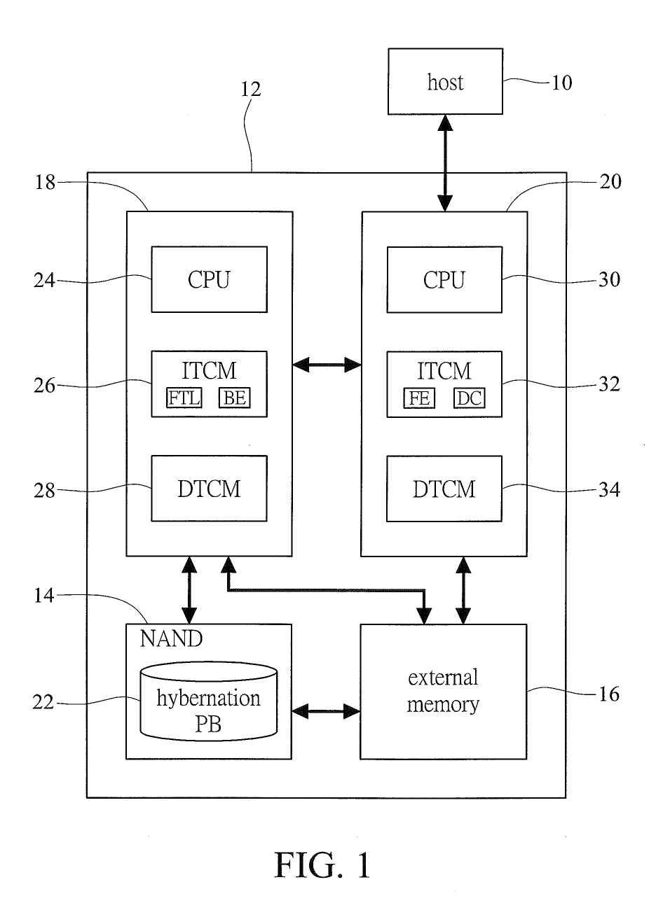

Host 10 and SSD 12 have been described above in RELATED PRIOR ART referring to FIG. 1. Host 10 is a personal computer such as a desk-top computer and a lap-top computer. As described above, SSD 12 includes NAND flash memory 14, external memory 16 and cores 18 and 20. SSD 12 can run a power management method according to the preferred embodiment of the present invention. More details of SSD 12 will be given to describe the power management method in detail.

NAND flash memory 14 includes a hibernation physical block 22 that is in fact a plurality of physical blocks of NAND flash memory 14 for storing data about the hibernation of SSD 12. Each of cores 18 and 20 includes an F/W code that is stored in hibernation physical block 22. The term, “external memory 16”, is used because it represents a memory that is located out of NAND flash memory 14 and cores 18 and 20.

In the power management method according to the present invention, external memory 16 is divided into a first portion and a second portion. The first portion is larger than the second portion. Reasons for dividing external memory 16 into the first and second portions will be given later. External memory 16 is connected to NAND memory 14.

As described above, core 18 includes CPU 24, ITCM 26 and DTCM 28. CPU 24 runs a software program to execute the power management method according to the present invention. ITCM 26 stores software programs to be run in CPU 24. DTCM 28 stores data needed in the operation of core 18 and, more particularly, CPU 24. For example, ITCM 26 receives a flash translation layer (“FTL”) and a back end (“BE”) from NAND flash memory 14 and stores the FTL and the BE. Then, CPU 24 receives the FTL and the BE from ITCM 26 and executes the FTL and the BE. The data stored in DTCM 28 include data required for or produced by CPU 24 in operation and the context of CPU 24. Core 18 is connected to NAND flash memory 14.

As described above, core 20 includes CPU 30, ITCM 32 and DTCM 34. CPU 30 runs a software program to execute the power management method according to the present invention. ITCM 32 stores software programs to be run in CPU 30. DTCM 34 stores data needed in the operation of core 20 and, more particularly, CPU 30. For example, ITCM 32 receives a front end (“FE”) and a data cache (“DC”) from NAND flash memory 14 and stores the FE and the DC. Then, CPU 30 receives the FE and the DC from ITCM 32 and executes the FE and the DC. The data stored in DTCM 34 include data required for or produced by CPU 30 in operation and the context of CPU 30.

Core 20 is connected to host 10. Cores 18 and 20 are connected to each other via a remote procedural call (“RPC”). Thus, CPU 24 is allowed to require CPU 30 to access to ITCM 32 and DTCM 34. In addition, CPU 30 is allowed to access to require CPU 24 to access to ITCM 26 and DTCM 28.

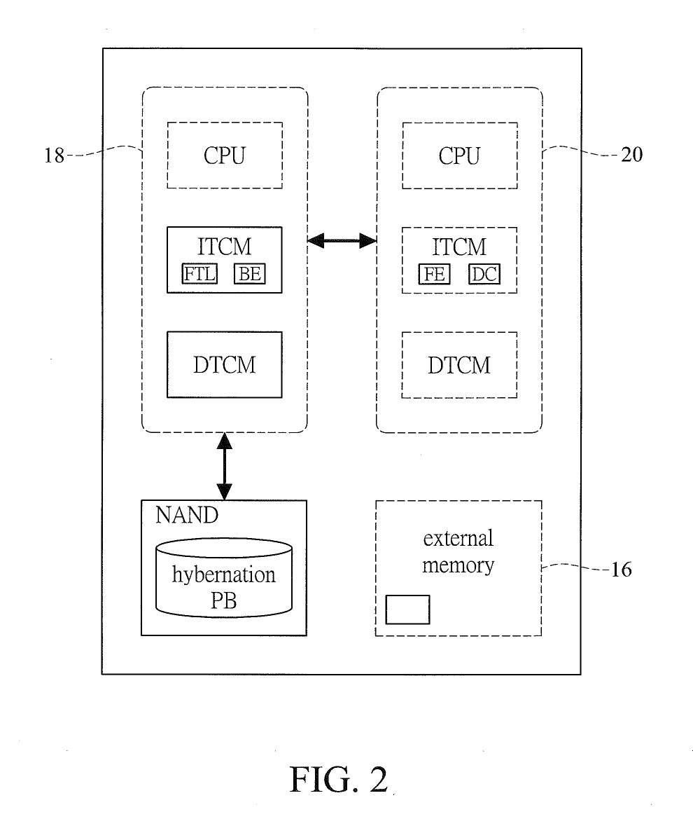

When an idle situation occurs, host 10 instructs core 20 to kick off the hibernation routine. Hence, core 20 starts the hibernation routine, and sends a notification to core 18. On receiving the notification, core 18 starts the hibernation routine, and tells core 20 that core 18 is ready for the hibernation. Referring to FIG. 2, after hearing from core 18, core 20 shuts down CPU 30 thereof and CPU 24, ITCM 26 and DTCM 28 of core 18, and the first portion of external memory 16. However, core 20 keeps ITCM 32 and DTCM 34 thereof and the second portion of external memory 16 awake. It should be noted that the data in the first portion of external memory 16 is written into NAND flash memory 14 before the hibernation. The data respectively written into NAND flash memory 14 and external memory 16 before the hibernation will be used in the wake-up routine.

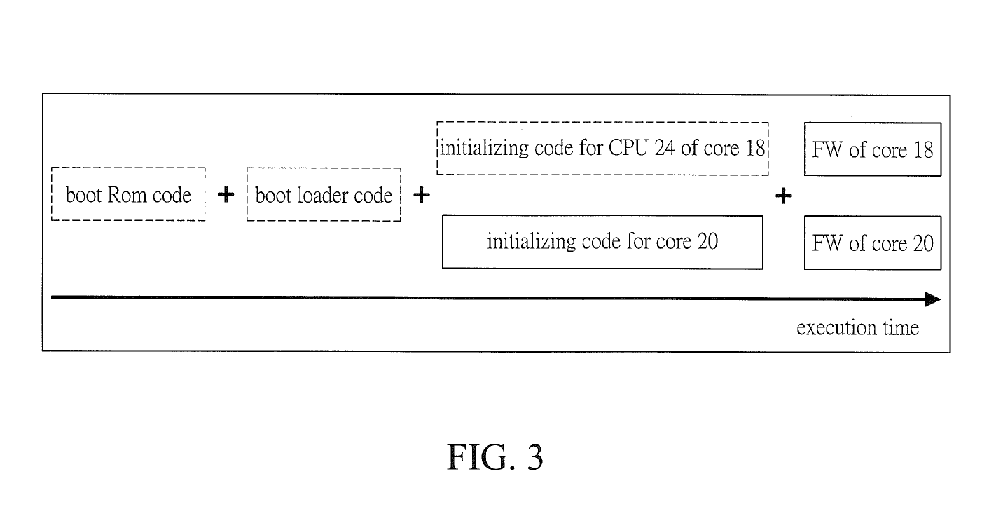

Referring to FIG. 3, the wakeup routine can be executed to wake up SSD 12 at a user's discretion. Immediately, CPU 24 is initialized, bypassing a boot-ROM code, a boot loader code, an initializing code of ITCM 26 and an initializing code of DTCM 28. SSD 12 knows that it should bypass the boot-ROM code, the boot loader code and the initializing codes because core 18 saves some flags to instruct SSD 12 before entering the hibernation. An initializing code for core 20 and firmware for core 20 are initialized while firmware for core 18 is initialized. The overall wake-up latency is reduced because there is no execution time for the boot-ROM code and the boot loader code for core 18. Core 18 restores the context thereof as well as the firmware of core 20 from hibernation physical block 22.

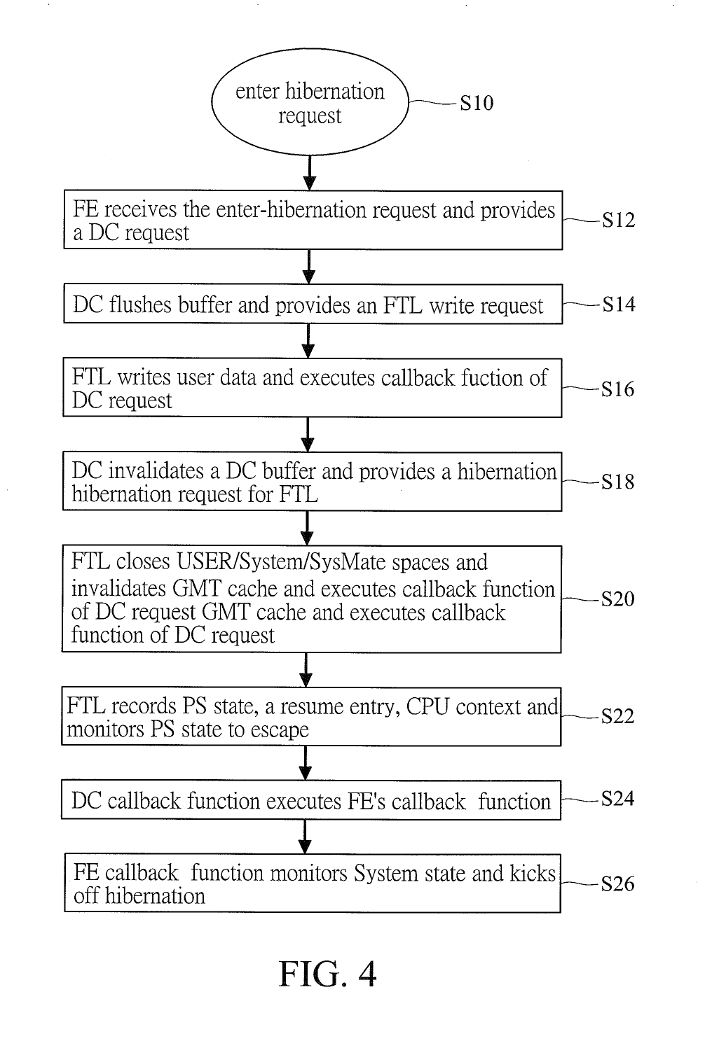

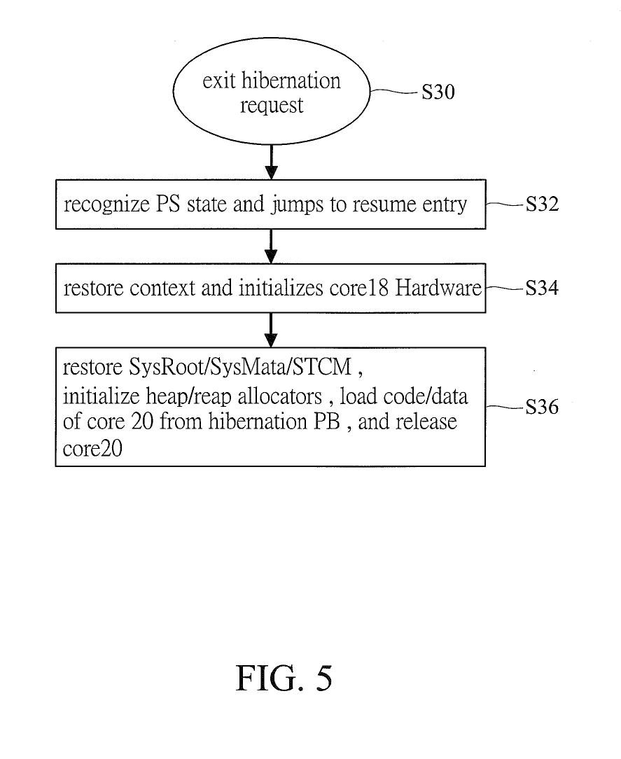

Referring to FIGS. 4 and 5, the power management method will be described in detail. The power management method includes a hibernation routine shown in FIG. 4 and a wakeup routine shown in FIG. 5.

Referring to FIG. 4, the power management method according to the present invention will be described in detail. According to the present invention, the power management method includes a hibernation routine and a wake-up routine.

At S10, host 10 provides a hibernation request.

At S12, the FE run in CPU 30 receives the hibernation request from host 10, and provides a DC write request.

At S14, according to the DC request, CPU 30 receives the DC from ITCM 32 and executes the DC to flush a DC buffer into NAND flash memory 14. Moreover, CPU 30 provides an FTL write request. The DC buffer is a block of external memory 16 (hardware) that is allocated to the DC (software).

At S16, according the FTL write request, CPU 24 receives the FTL from ITCM 26 and executes the FTL to write user data into NAND flash memory 14 from an FTL buffer. Furthermore, CPU 24 executes a callback function for the DC request. The FTL buffer is a block of external memory 16 (hardware) that is allocated to the FTL (software).

At S18, CPU 24 runs the DC to invalidate the DC buffer and provides the hibernation request for the FTL. As mentioned above, data have been written into NAND flash memory 14 from the DC buffer. That is, there are no data in the DC buffer, and there is no need to restore any data from the DC buffer. Hence, the DC buffer is invalidated.

At S20, CPU 24 runs the FTL to write User/System/SysMeta data into NAND flash memory 14, invalidates a related cache and executes a callback function for the DC request.

Briefly speaking, tasks are done at S14, S16 and S20 to write data into NAND flash memory 14 from external memory 16. At S14, a portion of the data stored in external memory 16 is written into NAND flash memory 14. At S16, another portion of the data stored in external memory 16 is written into NAND flash memory 14. At S20, the remaining data stored in external memory 16 are written into NAND flash memory 14.

At S22, the FTL records a hibernation state, a resume entry and the context of CPU 24 are written the second portion of external memory 16. Then, the FTL continues to monitor the power state to determine to enter or leave the hibernation.

At S24, the DC-callback function executes the FE callback function.

At S26, the FE callback function monitors the system state and kicks off the hibernation.

Referring to FIG. 5, at S30, SSD 12 receives a wake-up request from host 10.

At S32, the system recognizes hibernation and jumps to the resume entry.

At S34, the context of CPU 30 is restored, and core 20 is initialized.

At S36, the SysRoot/SysMeta/external memory 16 is restored, a heap/reap allocator is initialized, data are transferred back into ITCM 32 and DTCM from hibernation physical block 22, and core 20 is released.

Advantageously, the power management method according to the present invention shuts down the first portion of external memory 16, CPU 24 of core 18 and entire core 20 while keeping ITCM 26 and DTCM 28 of core 18 awake in the hibernation. The first portion of external memory 16, CPU 24 of core 18 and entire core 20 are shut down to reduce the power consumption in the hibernation. ITCM 26 and DTCM 28 of core 18 and the second portion of external memory 16 are kept awake in the hibernation, thereby allowing the wake-up subroutine to begin with the firmware of core 18, bypassing the boot-rom code, the boot loader code and the initializing code for core 18 to expedite the wake-up process, i.e., to reduce overall latency of SSD 12. Hence, the power management method according to the present invention reaches good balance between low power consumption and high performance.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A data storage apparatus comprising:
a NAND flash memory (14);
an external memory (16) comprising a first portion and a second portion smaller than the first portion;
a first core (18) comprising a CPU (24), an ITCM (26) and a DTCM (28); and
a second core (20) comprising a CPU (30), an ITCM (32) and a DTCM (34);
wherein the data storage apparatus is switchable between an operative state and a hibernation in which the NAND flash memory (14), the first portion of the external memory (16), the CPU (24) of the first core (18), and the CPU (30), ITCM (32) and DTCM (34) of the second core (20) are shut down while the second portion of the external memory (16) and the ITCM (26) and DTCM (28) of the first core (18) are kept awake.

2. A power management method for the data storage apparatus according to claim 1 comprising the steps of:
receiving a hibernation request from a host (10);
executing a hibernation routine comprising the steps of:
shutting down the first portion of the external memory (16) while allowing the second portion of the external memory (16) to continue to operate;
shutting down the CPU (24) of the first core (18) while allowing the ITCM (26) and DTCM (28) of the first core (18) to continue to operate;
shutting down the CPU (30), ITCM (32) and DTCM (34) of the second core (20); and
shutting down the NAND flash memory (14);
receiving a wake-up request; and
executing a wake-up routine comprising the steps of:
waking up the first portion of the external memory (16);
waking up the CPU (24) of the first core (18); and
waking up the CPU (30), ITCM (32) and DTCM (34) of the second core (20).

3. The power management method for according to claim 2, wherein the step of receiving a hibernation request from the host (10) comprises the steps of:
using the CPU (30) of the second core (20) to receive a FE from the ITCM (32) of the second core (20);
using the FE to receive the hibernation request from the host (10); and
providing a DC request.

4. The power management method for according to claim 3, further comprising the step of writing the data of the first portion of the external memory (16) into the NAND flash memory (14) before the step of shutting down the first portion of the external memory (16).

5. The power management method for according to claim 4, wherein the step of writing the data of the first portion of the external memory (16) into the NAND flash memory (14) comprises the steps of:
using the CPU (30) of the second core (20) to receive a DC from the ITCM (32) of the second core (20) and execute the DC to write data into the NAND flash memory (14) from a DC buffer;
using the CPU (24) of the first core (18) to receive an FTL from the ITCM (26) of the first core (20) and execute the FTL to write data into the NAND flash memory (14) from an FTL buffer; and
using the CPU (24) of the first core (18) to execute the FTL to write User/System/SysMeta data into the NAND flash memory (14).

6. The power management method for according to claim 3, further comprising the step of writing the data of the DTCM (34) of the second core (20) into the second portion of the external memory (16) before the step of shutting down the CPU (30), ITCM (32) and DTCM (34) of the second core (20).

7. The power management method for according to claim 2, wherein the hibernation routine comprises the steps:
using the CPU (30) of the second core (20) to receive an FE from the ITCM (32) of the second core (20), execute the FE to receive the hibernation request, and provide a DC request;
using the CPU (30) of the second core (20) to receive the DC from the ITCM (32) of the second core (20), execute the DC to write data into the NAND flash memory (14) from a DC buffer, and provide an FTL write request;
using the CPU (24) of the first core (18) to receive the FTL from the ITCM (26) of the first core (18), execute the FTL to write user data into the NAND flash memory (14) from a FTL buffer, and execute a callback function for the DC request;
using the CPU (30) of the second core (20) to execute the DC to invalidate the DC buffer and provide a hibernation request for the FTL;
using the CPU (24) of the first core (18) to execute the FTL to close User/System/SysMeta spaces, invalidate a GMT cache, and execute a callback function for the DC request;
using the FTL to record the power state, a resume entry and context of the CPU (24) of the first core (18) and monitor the power state;
using the DC callback function to execute a callback function for the FE; and
using the FE callback function to monitor the system state and kick off the hibernation.

8. The power management method for according to claim 3, wherein the wake-up routine comprises the steps:
recognizing the power state and jumping to the resume entry;
restoring the context of the CPU (24) of the first core (18) and initializing the first core (18); and
restoring the SysRot/SysMeta/external memory (16), initializing a heap/reap allocator, transferring data back into the ITCM (32) and DTCM (34) of the second core (20) from the NAND flash memory (14), and releasing the second core (20).
